(19) United States
(12) Patent Application Publication
(10) Pub. No.: US 2026/0202684 A1
(43) Pub. Date: Jul. 16, 2026

(54) PERSONALIZATION OF PROGRESSIVE LENSES

(71) Applicant: ADDON OPTICS LTD., Netanya (IL)

(72) Inventors: Dan Katzman, Givat Ela (IL); Yuval Carmon, Kiryat Tivon (IL); Haim Engler, Hasmonaim (IL); Jed Arkin, Savyon (IL); Amir Erlichman, Herzelia (IL)

(21) Appl. No.: 19/127,877

(22) PCT Filed: Nov. 3, 2023
(86) PCT No.: PCT/IB2023/061107

§ 371 Date: May 7, 2025

Related U.S. Application Data
(60) Provisional application No. 63/424,915, filed on Nov. 13, 2022.

(51) Int. Cl. G02C 7/06; G02C 7/02

(52) U.S. Cl. CPC G02C 7/065; G02C 7/024; G02C 2202/08; G02C 2202/16; G02C 2202/24

(57) ABSTRACT

Apparatus and methods are described for use with a frame (21) of glasses (18) that are to be worn by a wearer. A progressive lens (20) is configured to provide a far-vision corrective functionality and a near-vision corrective functionality. The progressive lens includes a bespoke, single-vision base lens (22) that is configured to provide at least a portion of the far-vision corrective functionality, the bespoke lens being formed so as to accommodate ophthalmic requirements of the wearer, and/or requirements of the glasses frame (21). The progressive lens further includes an additional lens (24) coupled to the bespoke, single-vision base lens (22), the additional lens (24) being configured to provide progressive near-vision corrective functionality. Other applications are also described.

### CROSS-REFERENCE TO RELATED APPLICATIONS

The present application claims priority from U.S. Provisional Patent Application No. 63/424,915 to Katzman, filed Nov. 13, 2022, entitled “Personalization of progressive lenses,” which is incorporated herein by reference.

### FIELD OF EMBODIMENTS OF THE INVENTION

Some applications of the present invention generally relate to ophthalmic lenses. In particular, some applications relate to manufacturing a progressive lens using a bespoke base lens and an additional lens that is coupled to the bespoke base lens.

### BACKGROUND

Presbyopia is a condition that gradually affects most of the population over age 40. The condition results in progressively worsening ability to focus clearly on close objects even if the subject is using vision correction for far away objects. Presbyopia is usually treated with multifocal eyeglasses, progressive eyeglasses or contact lenses, since laser-assisted in situ keratomileusis (i.e., LASIK) and other types of surgery are unsuitable for treating this condition. In some cases, presbyopia is treated with the implantation of an intraocular lens that accounts for the presbyopia.

Corrective lenses are used in eyeglasses to correct presbyopia and other disorders of accommodation. Many people who suffer from presbyopia, additionally suffer from myopia or hyperopia (i.e., near-sightedness or far-sightedness, respectively). A basic solution for such people is the use of multifocal spectacle lenses. Multifocal spectacle lenses contain two or more lens powers, with each power being suitable for objects that are at respective distances. Bifocals contain two lens powers; trifocals contain three. Progressive spectacle lenses are characterized by a gradient of increasing lens power. The gradient starts at the patient's distance prescription and reaches a maximum addition power, or the full reading addition, in the lower portion of the lens. The addition in the middle of the lens usually enables clear vision in intermediate ranges, such as reading text on a computer screen. The length of the progressive power gradient on the lens surface depends on the design of the lens, with a final addition power typically being between 0.50 and 3.50 Diopters. The addition value prescribed depends on the level of presbyopia of the patient.

Freeform lenses are lenses that may be manufactured in a bespoke manner to suit the needs of a particular patient. In some cases, freeform lenses are processed (e.g., using milling, using a lathe, polishing and/or engraving) so as to be optimized for a particular frame. Typically, specialized software is used to calculate curvatures that are to be formed in a lens, in order to create a lens that satisfies a given set of requirements. The lens is then processed using specialized cutting equipment that is able to form the lens to within very small tolerances.

It is noted that there are other types of surfaced lenses that rely upon less specialized techniques than the aforementioned freeform techniques for processing the surface of the lens. Conventionally, bespoke lenses are cut and polished using hard tools according the patient's prescription and including any required prism. The tools are usually aluminum tools having a spherical or toric surface, usually in quarter or eighth diopter increments. Such tools typically have to be stocked separately for each refraction index, such that laboratories that use such methods must stock a large number of tools. The above-described freeform technology is considered to be advantageous relative to the conventional methods in that the freeform technology does not require a large number of cutting and polishing tools to be stocked.

### SUMMARY OF EMBODIMENTS

In accordance with some applications of the present invention, a progressive lens that is configured to provide a far-vision correction and a near-vision correction, includes (a) a bespoke, single-vision base lens (also referred to herein as the “bespoke base lens” or the “base lens”) that typically provides far-vision corrective functionality, and (b) an additional lens that is coupled to the base lens that provides progressive near-vision corrective functionality. Typically, the additional lens provides near vision correction and a transitionary progressive corridor between near and far vision. The additional lens is typically coupled to the back side of the bespoke base lens, i.e., the concave side of the base lens, which is closer to the patient's face when glasses in which the progressive lens is disposed are worn by the patient. For some applications, the base lens provides all of the far-vision corrective functionality that is provided by the combined lens. Alternatively, in some applications, the base lens provides only a portion of the far-vision corrective functionality that is provided by the combined lens and the additional lens provides the remainder of the desired far-vision corrective functionality to the progressive lens (e.g., as described in U.S. Pat. No. 11,378,821 to Katzman, which is incorporated herein by reference).

The bespoke base lens is typically designed according to the particular ophthalmic requirements of the wearer (e.g., sphere, cylinder, and/or axis), and/or the requirements of the glasses frame in which the progressive lens is to be placed. For some applications, the bespoke base lens includes an aspheric correction, anti-fatigue correction, oblique aberration correction, and/or myopia-control correction. For some applications, the base lens is a surfaced lens, such as a freeform lens. It is noted that although the base lens is described as being a single-vision lens, this term should be interpreted to mean that the base lens is substantially single-vision, and this term should not be interpreted as excluding corrections that are made to the overall single-vision curvature of the lens, such as the aforementioned corrections. Even in the case of such corrections, the base lens is a substantially single-vision lens, in that any such corrections typically change the mean power of the base lens in the near vision measuring position by no more than 0.125 Diopters relative to the mean power of the base lens at the far vision measuring position. For some applications, the additional lens includes one or more corrections, such as aspheric correction, spherical and/or cylindrical correction, anti-fatigue correction, and/or myopia-control correction.

It is noted that the use of a combination of a base lens and an additional optical element (such as an additional film or an additional lens) to provide a progressive lens has been described in U.S. Pat. No. 9,995,948 to Arieli (which is incorporated herein by reference) and in U.S. Pat. No. 11,378,821 to Katzman. However, whereas previous applications (such as U.S. Pat. No. 11,378,821 to Katzman) have described the use of a single-vision, rigid stock lens as a base lens, in accordance with some applications of the present application, the base lens is a bespoke, single-vision lens (e.g., a freeform lens). Using a single-vision, rigid stock lens as the base lens typically allows a large number of prescriptions to be provided using a relatively small stock of lenses. However, the use of a bespoke, single-vision lens (e.g., a freeform lens) as the base lens as described herein, may provide one or more advantages relative to using a single-vision, rigid stock lens as the base lens, as set forth in further detail hereinbelow. In addition, manufacturing the progressive lens using a combination of a bespoke, single-vision base lens (e.g., a freeform base lens) and an additional lens may provide one or more advantages over using a single-piece, bespoke progressive lens, e.g., a single-piece, freeform lens.

For some applications, the additional lens is a rigid lens. Alternatively, the additional lens is a flexible film. Typically, the additional lens is flexible under a given set of conditions (e.g., when the film is heated to above a given temperature), whereas, under typical ambient conditions (e.g., at a temperature of less than 50 degrees Celsius), the additional lens is substantially rigid, such that the additional lens has the characteristics of a rigid lens. Typically, the set of conditions are applied to the additional lens during the manufacture of the progressive lens, and, in particular, when the additional lens is coupled to the bespoke base lens. Thus, the flexibility of the additional lens permits the additional lens to conform with the shape of the bespoke base lens. For example, the additional lens may be heated to above a given temperature during the manufacture of the progressive lens, and, in particular, when the additional lens is coupled to the bespoke base lens. Typically, even when placed under the given conditions (e.g., when heated above the given temperature), the additional lens is configured to maintain its optical characteristics. Subsequent to the additional lens having been adhered to the bespoke base lens so as to form the progressive lens, the progressive lens is placed under ambient conditions (e.g., a temperature of less than 50 degrees Celsius), such that the additional lens typically assumes a rigid state. For some applications, the progressive lens is manufactured from a combination of a base lens and an additional lens using generally similar techniques to those described in U.S. Ser. No. 17/904,269 to Halahmi, which is the US national phase of WO 2021/198822 to Halahmi, and which is incorporated herein by reference, mutatis mutandis.

As described hereinabove, the additional lens is typically coupled to the back side of the bespoke base lens. Typically, for such applications, one or more functional coatings (such as a hard coating, an anti-reflective coating, a super-hydrophobic coating, an antistatic coating, a clean coating, a blue-light filter, a reflective coating, an anti-UV coating, a photochromic coating, a polarizing coating, a tinting coating, a mirror coating, or any combination thereof) are pre-applied to the front surface of the bespoke base lens, and the back surface of the bespoke base lens is processed according to a patient's particular needs. Further typically, the additional lens that is used with the bespoke lens is selected from a relatively small stock of non-bespoke additional lenses and one or more of the above-described functional coatings are pre-applied to the back surface of the additional lens. (It is noted that the coatings that are applied to the back surface of the additional lens are not necessarily identical to the coatings that are applied to the front surface of the bespoke base lens.) Thus, once the progressive lens is formed from the combination of the base lens and the additional lens, both the front and back surfaces of the progressive lens are coated with the one or more coatings. For some applications, the additional lens is coupled to the front side of the bespoke base lens, in which case the front surface of the additional lens and the back surface of the base lens are typically coated with the pre-applied coatings.

There is therefore provided, in accordance with some embodiments of the present invention, an apparatus for use with a frame of glasses that are to be worn by a wearer, the apparatus including:
a progressive lens that is configured to provide a far-vision corrective functionality and a near-vision corrective functionality, the progressive lens including:
   a bespoke, single-vision base lens that is configured to provide at least a portion of the far-vision corrective functionality, the bespoke lens being formed so as to accommodate ophthalmic requirements of the wearer, and/or requirements of the glasses frame; and
   an additional lens coupled to the bespoke, single-vision base lens, the additional lens being configured to provide progressive near-vision corrective functionality.

In some embodiments, the bespoke, single-vision base lens provides all of the far-vision corrective functionality of the progressive lens.

In some embodiments, the bespoke, single-vision base lens provides only a portion of the far-vision corrective functionality of the progressive lens and the additional lens provides a remainder of the far-vision corrective functionality of the progressive lens.

In some embodiments, the additional lens is a stock lens.

In some embodiments, the bespoke, single-vision base lens is a freeform lens.

In some embodiments, the bespoke, single-vision base lens is a bespoke, single-vision base lens formed using hard-tool cutting and polishing.

In some embodiments, the bespoke, single-vision base lens is formed to accommodate ophthalmic requirements of the wearer selected from the group consisting of: sphere, cylinder, and axis.

In some embodiments, the bespoke, single-vision base lens is formed with single-vision refractive properties that are calculated to create an as-worn prescription that incorporates personalized ophthalmic parameters of the wearer.

In some embodiments, the bespoke, single-vision base lens is formed to compensate for any effect on personalized ophthalmic parameters that will be caused by the coupling of the additional lens to the bespoke, single-vision lens.

In some embodiments, the bespoke, single-vision base lens is formed to accommodate a clinical prism prescription of the wearer, such that the progressive lens has a required clinical prism correction at a prism reference point of the progressive lens.

In some embodiments, there is a thickness difference between top and bottom edges of the additional lens, and prism-thinning is introduced to the bespoke, single-vision base lens, such that there is a thickness difference between top and bottom edges of the bespoke, single-vision base lens that at least partially compensates for the thickness difference between the top and bottom edges of the additional lens.

In some embodiments, residual optical properties are added in a periphery of the bespoke, single-vision base lens, so as to compensate for undesired residual peripheral aberrations that are caused by a discrepancy between prescription powers for which the additional lens was designed and a prescription which the wearer requires.

In some embodiments, the bespoke, single-vision base lens is formed with an unedged diameter that is optimized to accommodate a shape of the frame of the glasses.

In some embodiments, each of the bespoke, single-vision base lens and the additional lens has a thickness at a given region that results in a lens having structural strength that is below a given threshold for that region, but the progressive lens has a structural strength at the given region that is above the threshold.

In some embodiments, a combination of the bespoke, single-vision base lens and the additional lens has a structural strength at a given region that is below a threshold for that region, and the additional lens is coupled to the bespoke, single-vision base lens with an adhesive that acts as a shock absorber such that the progressive lens has a structural strength at the given region that is above the threshold.

In some embodiments, residual optical properties are added in a periphery of the bespoke, single-vision base lens, so as to compensate for a mismatch between a face form angle for which the additional lens is designed, and a face form angle of the frame of the glasses.

In some embodiments, the residual optical properties that are added are configured to account for a plurality of personalized ophthalmic parameters of the wearer.

In some embodiments, the residual optical properties that are added are configured to account for one or more personalized ophthalmic parameters of the wearer selected from the group consisting of: back vertex distance, pantoscopic tilt, and prism.

In some embodiments, the progressive lens includes one or more functional coatings that were pre-applied to at least one of a front surface of the progressive lens and a back surface of the progressive lens, prior to the additional lens being coupled to the bespoke, single-vision base lens.

In some embodiments, the one or more functional coatings include one or more functional coatings selected from the list consisting of: a hard coating, an anti-reflective coating, a super-hydrophobic coating, an antistatic coating, a clean coating, a blue-light filter, a reflective coating, an anti-UV coating, a photochromic coating, a tinting coating, and a mirror coating.

In some embodiments, the progressive lens includes a first set of one or more functional coatings that were pre-applied to the front surface of the progressive lens and includes a second set of one or more functional coatings that were pre-applied to the back surface of the progressive lens, prior to the additional lens being coupled to the bespoke, single-vision base lens.

In some embodiments, the first set of one or more functional coatings that were pre-applied to the front surface of the progressive lens are the same as the second set of one or more functional coatings that were pre-applied to the back surface of the progressive lens.

In some embodiments, the first set of one or more functional coatings that were pre-applied to the front surface of the progressive lens are different from the second set of one or more functional coatings that were pre-applied to the back surface of the progressive lens.

In some embodiments, there is a thickness difference between top and bottom edges of the additional lens, and prism-thinning is introduced to the bespoke, single-vision base lens, such that top and bottom edges of the bespoke, single-vision base lens do not compensate for the thickness difference between the top and bottom edges of the additional lens, such that there is a difference between the thicknesses of top and bottom edges of the progressive lens.

In some embodiments, the progressive lens has an average thickness on its edged contour that is lower than it would be if the bespoke single vision lens provided prism-thinning, such that top and bottom edges of the bespoke, single-vision base lens compensated for the thickness difference between the top and bottom edges of the additional lens.

In some embodiments, the bespoke, single-vision base lens includes one or more corrections selected from the group consisting of: aspheric correction, anti-fatigue correction, oblique aberration correction, and/or myopia-control correction.

In some embodiments, the selected one or more corrections change a mean power of the bespoke, single-vision base lens at a near vision measuring position by no more than 0.125 Diopters relative to a mean power of the bespoke, single-vision base lens at a far vision measuring position.

There is further provided, in accordance with some embodiments of the present invention, a method for use with a frame of glasses that are to be worn by a wearer, the method including:
manufacturing a progressive lens for placement in the glasses frame by:
coupling to each other:
   a bespoke, single-vision base lens that is configured to provide at least a portion of the far-vision corrective functionality, the bespoke lens being formed so as to accommodate ophthalmic requirements of the wearer, and/or requirements of the glasses frame; and
   an additional lens coupled to the bespoke, single-vision base lens, the additional lens being configured to provide progressive near-vision corrective functionality.

In some embodiments, the bespoke, single-vision base lens provides all of the far-vision corrective functionality of the progressive lens.

In some embodiments, the bespoke, single-vision base lens provides only a portion of the far-vision corrective functionality of the progressive lens and the additional lens provides a remainder of the far-vision corrective functionality of the progressive lens.

In some embodiments, the additional lens is a stock lens.

In some embodiments, the bespoke, single-vision base lens is a freeform lens.

In some embodiments, the bespoke, single-vision base lens is a bespoke, single-vision base lens formed using hard-tool cutting and polishing.

In some embodiments, the bespoke, single-vision base lens is formed to accommodate ophthalmic requirements of the wearer selected from the group consisting of: sphere, cylinder, and axis.

In some embodiments, the bespoke, single-vision base lens is formed with single-vision refractive properties that are calculated to create an as-worn prescription that incorporates personalized ophthalmic parameters of the wearer.

In some embodiments, the bespoke, single-vision base lens is formed to compensate for any effect on personalized ophthalmic parameters that will be caused by the coupling of the additional lens to the bespoke, single-vision lens.

In some embodiments, the bespoke, single-vision base lens is formed to accommodate a clinical prism prescription of the wearer, such that the progressive lens has a required clinical prism correction at a prism reference point of the progressive lens.

In some embodiments, there is a thickness difference between top and bottom edges of the additional lens, and the bespoke, single-vision base lens has been prism-thinned, such that there is a thickness difference between top and bottom edges of the bespoke, single-vision base lens that at least partially compensates for the thickness difference between the top and bottom edges of the additional lens.

In some embodiments, the bespoke, single-vision base lens has had residual optical properties added to its periphery, so as to compensate for undesired residual peripheral aberrations that are caused by a discrepancy between prescription powers for which the additional lens was designed, and a prescription which the wearer requires.

In some embodiments, the bespoke, single-vision base lens includes a bespoke, single-vision base lens formed with an unedged diameter that is optimized to accommodate a shape of the frame of the glasses.

In some embodiments, each of the bespoke, single-vision base lens and the additional lens has a thickness at a given region that results in a lens having structural strength that is below a given threshold for that region, and coupling the bespoke single-vision base lens to the additional lens includes forming a progressive lens that has a structural strength at the given region that is above the threshold.

In some embodiments, a combination of the bespoke, single-vision base lens and the additional lens has a structural strength at a given region that is below a threshold for that region, and coupling the bespoke single-vision base lens to the additional lens includes coupling the bespoke single-vision base lens to the additional lens with an adhesive that acts as a shock absorber such that the progressive lens has a structural strength at the given region that is above the threshold.

In some embodiments, the bespoke, single-vision base lens includes a bespoke, single-vision base lens to which residual optical properties have been added in its periphery, so as to compensate for a mismatch between a face form angle for which the additional lens is designed, and a face form angle of the frame of the glasses.

In some embodiments, the residual optical properties are configured to account for a plurality of personalized ophthalmic parameters of the wearer.

In some embodiments, the residual optical properties are configured to account for one or more personalized ophthalmic parameters of the wearer selected from the group consisting of: back vertex distance, pantoscopic tilt, and prism.

In some embodiments, coupling the bespoke single-vision base lens to the additional lens includes coupling the bespoke single-vision base lens to the additional lens with one or more functional coatings having been pre-applied to at least one of a front surface of the progressive lens and a back surface of the progressive lens, prior to the bespoke, single-vision base lens being coupled to the additional lens.

In some embodiments, the one or more functional coatings include one or more functional coatings selected from the list consisting of: a hard coating, an anti-reflective coating, a super-hydrophobic coating, an antistatic coating, a clean coating, a blue-light filter, a reflective coating, an anti-UV coating, a photochromic coating, a tinting coating, and a mirror coating.

In some embodiments, coupling the bespoke single-vision base lens to the additional lens includes coupling the bespoke single-vision base lens to the additional lens with a first set of one or more functional coatings having been pre-applied to the front surface of the progressive lens and a second set of one or more functional coatings having been pre-applied to the back surface of the progressive lens, prior to the bespoke, single-vision base lens being coupled to the additional lens.

In some embodiments, the first set of one or more functional coatings that were pre-applied to the front surface of the progressive lens are the same as the second set of one or more functional coatings that were pre-applied to the back surface of the progressive lens.

In some embodiments, the first set of one or more functional coatings that were pre-applied to the front surface of the progressive lens are different from the second set of one or more functional coatings that were pre-applied to the back surface of the progressive lens.

In some embodiments, there is a thickness difference between top and bottom edges of the additional lens, and the bespoke, single-vision base lens includes a bespoke, single-vision base lens to which prism-thinning has been applied, such that top and bottom edges of the bespoke, single-vision base lens do not compensate for the thickness difference between the top and bottom edges of the additional lens, such that there is a difference between the thicknesses of top and bottom edges of the progressive lens.

In some embodiments, the progressive lens has an average thickness on its edged contour that is lower than it would be if the bespoke single vision lens provided prism-thinning, such that top and bottom edges of the bespoke, single-vision base lens compensated for the thickness difference between the top and bottom edges of the additional lens.

In some embodiments, the bespoke, single-vision base lens includes one or more corrections selected from the group consisting of: aspheric correction, anti-fatigue correction, oblique aberration correction, and/or myopia-control correction.

In some embodiments, the selected one or more corrections change a mean power of the bespoke, single-vision base lens at a near vision measuring position by no more than 0.125 Diopters relative to a mean power of the bespoke, single-vision base lens at a far vision measuring position.

The present invention will be more fully understood from the following detailed description of embodiments thereof, taken together with the drawings, in which:

### BRIEF DESCRIPTION OF THE DRAWINGS

FIG. 1 is a schematic illustration of a pair of glasses that contains one or more lenses that are made up of a base lens and an additional lens adhered to the base lens, in accordance with some applications of the present invention; and

FIG. 2 is a schematic illustration of a cross-sectional view of a combined lens, in accordance with some applications of the present invention.

### DETAILED DESCRIPTION OF EMBODIMENTS

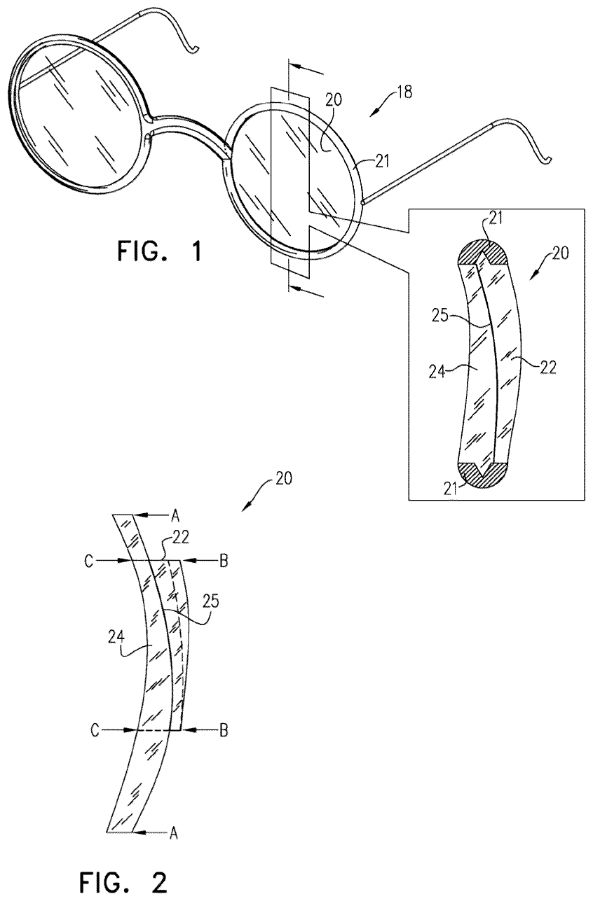

Reference is now made to FIG. 1, which is a schematic illustration of a pair of glasses 18 that includes one or more combined lenses 20 within a glasses frame 21. Each of the combined lenses is made up of a base lens 22 and an additional lens 24 adhered to the base lens, in accordance with some applications of the present invention. For some applications, combined lens 20 is a progressive lens that is configured to provide a far-vision correction and a near-vision correction. For some such applications, base lens 22 is a bespoke, single-vision base lens (also referred to herein as the “bespoke base lens” or the “base lens”) that typically provides far-vision corrective functionality and additional lens 24 is an additional lens that is coupled to the base lens and that provides progressive near-vision corrective functionality. Typically, the additional lens provides near vision correction and a transitionary progressive corridor between near and far vision. The additional lens is typically coupled to the back side of the bespoke base lens, i.e., the concave side of the base lens, which is closer to the patient's face when glasses in which the progressive lens is disposed are worn by the patient. For some applications, additional lens is coupled to the back side of the bespoke base lens using a layer of adhesive 25. In some applications, the additional lens also provides a portion of the desired far-vision corrective functionality to the progressive lens (e.g., as described in U.S. Pat. No. 11,378,821 to Katzman, which is incorporated herein by reference).

As shown in the cross-sectional view of combined lens 20, additional lens 24 is typically coupled to the back side of base lens 22, i.e., the concave side of the base lens, which is closer to the patient's face when glasses 18 are worn by the patient. In some applications, the additional lens is coupled to the front side of the base lens, i.e., the convex side of the base lens, which is farther from the patient's face when glasses 18 are worn by the patient. The additional lens is typically coupled to the base lens using an adhesive.

### Advantages Over Using Singe-Vision, Rigid Stock Lens as Base Lens

As described hereinabove, the use of a bespoke, single-vision lens (e.g., a freeform lens, or a lens produced by conventional methods using hard tools) as the base lens, as described herein, may provide one or more advantages relative to using a single-vision, rigid stock lens as the base lens. When a progressive lens is formed using a single-vision, rigid stock lens as the base lens using techniques such as those described in U.S. Pat. No. 11,378,821 to Katzman, the additional lens that is used in combination with the base lens is typically not designed to a patient's personal parameters, but rather, to some perceived market averages or some averages of the prescription range. Examples of such parameters are back vertex distance, pantoscopic tilt, panoramic tilt, frame shape, fitting information, base curve, thinning prism and sphere. All of these personalized parameters cannot be taken into account for adjusting the progressive lens design because all of the components of the progressive lens are already fabricated by the time such individual values are known, given that the component lenses of the progressive lens are mass produced. By contrast, when the progressive lens is formed using a bespoke, single-vision, base lens (e.g., a freeform lens, or a lens produced by conventional methods using hard tools), the progressive lens is typically designed so as to be personalized according to the patient's personal parameters. Some of these parameters are as follows:

### As-Worn Prescription

When designing a bespoke lens, it is quite common to consider personalized ophthalmic parameters, such as prism, pantoscopic tilt, face form angle, base curve, and back vertex distance, to calculate a compensated patient prescription (also referred to herein as the “as-worn prescription”). This is particularly the case for lenses that are manufactured using freeform technology, but such techniques can also be applied to lenses formed using conventional methods using hard tools. The compensated patient prescription allows the patient to perceive the prescription that was ordered for the patient by the optician when wearing the glasses with the above-mentioned personalized parameters (as measured in the as-worn position). However, since the lens is verified with a lens meter in which the lens is not oriented in the as-worn position, the reading of such as-worn lenses in lens meters usually does not yield values that are meant to be integer multiples of a quarter or one-eighth diopter, as is the industry standard. For this reason, composite lenses composed of single-vision, rigid stock lenses and additional lenses cannot yield progressive lenses with an as-worn prescription. However, if a bespoke, single-vision lens (e.g., a freeform lens) is used as the base lens, the single-vision refractive properties (such as sphere, cylinder and axis) can be calculated to create a correct as-worn prescription that incorporates the personalized parameters. Moreover, the addition of the additional lens to the bespoke base lens may affect or be affected by some of the aforementioned personalized ophthalmic parameters. For some applications, this is accounted for by forming the bespoke lens so as to compensate for any effect on the personalized ophthalmic parameters that will be caused by the addition of the additional lens to the bespoke base lens, or for any effects that the personalized ophthalmic parameters may have on the additional lens by the addition of the additional lens to the bespoke base lens.

### Peripheral Design

In the above section, the concept of the as-worn prescription was discussed, i.e., the concept of optimizing the lenses such that the patient perceives the correct prescription when wearing glasses in the as-worn position. This approach, however, only changes the lens in four degrees of freedom (sphere, cylinder, axis, and addition), which are measured at the lens meter control points (so as to control for far vision and near vision). This does not address the deterioration of the lens design as the values of the personalized parameters change in relation to the ones for which the additional lens was originally designed. As an example, let us consider an additional lens that was designed for a face form angle of 5 degrees. If one now wants to use this additional lens in a wrap-around frame, the face form angle will be much larger, e.g., on the order of more than 20 degrees, e.g. 30 degrees. In this case, even if a base lens is processed with an appropriate as-worn prescription, the patient would get pristine perceived optics at the control points, but the residual optical design at the periphery may not be optimal. Therefore in accordance with some applications, residual optical properties are added in the periphery of the bespoke, single-vision, base lens produced using freeform technology, so as to compensate for the mismatch between the face form angle for which the original additional lens was designed, and the one which the patient is using (i.e., the face form angle of the frame of the glasses). Typically, a peripheral compensation is not calculated for each individual property separately. Rather, all of the personalized ophthalmic parameters (i.e., back vertex distance, pantoscopic tilt, and/or prism) are typically compensated for as a single combination.

In addition to the above, it is known that the peripheral aberrations of a lens also strongly depend on the sphere, cylinder power, and cylinder axis of the prescription. The additional lenses, however, are typically optimized for a relatively wide range of sphere and cylinder values. For some applications, the bespoke base lens is designed so as to compensate for the residual peripheral aberration discrepancy resulting from discrepancy between the prescription powers for which the additional lens was designed, and the prescription which the individual patient needs at the far and near measuring positions.

### Prism and Prism Thinning

Prism is difficult to attain when manufacturing a progressive lens using a single-vision, rigid stock lens as the base lens and an additional lens, because prism can only be introduced by laterally moving the additional lens in relation to the base lens. The physical diameters of the base lens and the additional lens and their respective prescriptions create a significant physical constraint on the amount of prism that can be introduced to the progressive lens.

For some applications, when a bespoke lens (e.g., a freeform lens, or a lens produced by conventional methods using hard tools) is used as the base lens, clinical prism is introduced to the base lens so that the progressive lens composed of the base lens and the additional lens has the required clinical prism correction at the prism reference point. Typically, the additional lenses are not well suited for correction of clinical prism. This is because, as described hereinabove, the additional lenses are typically not manufactured in a bespoke manner, so the clinical prism of the patient is not known when the additional lens is manufactured.

Similar to the case described above for clinical prism correction, for some applications, when a bespoke lens (e.g., a freeform lens or a lens produced by conventional methods using hard tools) is used as the base lens, prism thinning is introduced to the base lens. Typically, the additional lenses are not well suited to prism thinning. This is because, as described hereinabove, the additional lenses are typically not manufactured in a bespoke manner, so the frame shape and fitting information are not known when the additional lenses are manufactured and only become known once an individual order for a particular patient is created. Adhesion of the prism-thinned single-vision base lens to the additional lens would therefore yield a lens that is not balanced for thickness on the edged lenses. However, for some applications, the right amount of prism-thinning is introduced to the bespoke, single-vision lens, such that there is a thickness difference between the top and bottom edges of the bespoke lens after it has been edged to the frame shape that at least partially compensates for the thickness difference between the top and bottom edges of the additional lens. Thus, when the progressive lens is formed from the combination of the bespoke base lens and the additional lens (both of which have been edged to the frame shape), the overall progressive lens has the same thickness at its top and bottom edges (or has a thickness difference between its top and bottom edges that is less than if the prism-thinning had not been introduced to the bespoke, single-vision lens).

For some alternative applications, prism-thinning is applied to the bespoke base lens, but the prism-thinning is applied such that relative thicknesses of the top and bottom edges of the bespoke base lens after it has been edged to the frame shape do not compensate for the thickness difference between the top and bottom edges of the additional lens. For example, the prism-thinning may be applied to the bespoke base lens such that, after it has been edged to the frame shape, the top and bottom edges of the bespoke base lens are of the same or similar thicknesses (e.g., thicknesses that differ by less than 10 percent of the thickness of the lesser of the two thicknesses), and the additional lens is combined with the prism-thinned bespoke base lens, such that there is a difference between the thicknesses of the top and bottom edges of the overall progressive lens. For some such applications, this yields a progressive lens having an average thickness on the edged contour that is lower than it would be if the overall progressive lens (i.e., the combination of the base lens and the additional lens which is not edge balanced on the frame edge) had the same thickness at its top and bottom edges.

Reference is now made to FIG. 2, which is a schematic illustration of a cross-sectional view of combined lens 20, in accordance with some applications of the present invention. As described hereinabove, the combined lens is made of base lens 22 and additional lens 24, which are typically coupled to each other via adhesive 25. The additional lens is typically mass produced such that it initially is not edged for a specific frame, and has pre-cut edges designated by the letter “A” in FIG. 2. Typically, the thickness of the additional lens at its top and bottom edges is equal prior to the lens being edged. Typically, the lens is edged for a specific frame, such that its edged contours are as indicated by the letter “C” in FIG. 3. As shown, once the additional lens is edged for the frame shape, the additional lens does not have equal thicknesses at its top and bottom edged contours.

As described hereinabove, in some applications, the bespoke single vision lens is designed to compensate for the thickness difference between the top and bottom edges of the additional lens, while maintaining a thickness that is higher than a prescribed minimum thickness along the edges. The outline of the cross-section of such a lens is indicated by the solid lines, with its top and bottom edges being designated by the letter “B” in FIG. 2. As may be observed, the thickness of bottom edge B of the bespoke single vision lens is less than that of the top edge B of the bespoke single vision lens, whereas the thickness of bottom edged contour C of the additional lens is greater than that of top edged contour C of the bespoke single vision lens. Thus, the bespoke single vision lens is designed to compensate for the thickness difference between the top and bottom edges of the additional lens, while maintaining a thickness that is higher than a prescribed minimum thickness along the edges.

Also as described hereinabove, in some alternative embodiments, prism-thinning is applied to the bespoke base lens, but the prism-thinning is applied such that relative thicknesses of the top and bottom edges of the bespoke base lens after it has been edged to the frame shape do not compensate for the thickness difference between the top and bottom edges of the additional lens. This is indicated by the dashed curve within the bespoke single vision lens 22 within FIG. 2. For some applications, the outer surface of bespoke single vision lens 22 is as indicated by the dashed curve. As shown, in some applications, bespoke single vision lens 22 has equal thicknesses at top and bottom edges B, while maintaining a thickness that is higher than a prescribed minimum thickness along the edges. Typically, in such cases, there is a difference between the thicknesses of the combined lens at the top and bottom edges. Further typically, as shown, in such cases, the combined lens has an average maximum thickness on the edged contour that is lower than it would be if the combined lens had the same thickness at its top and bottom edges.

### Thickness Optimization

Those familiar with ophthalmic lens manufacturing and dispensing know that there is a trade-off that must be considered when deciding on the lens thickness. On the one hand, thin lenses are more cosmetically appealing, and are more comfortable to wear as spectacles due to their lower weight. On the other hand, lenses must be thick enough to be structurally strong enough to meet industry-standard regulations. The goal, therefore, is to produce lenses that are as thin as possible but are still thick enough to be robust to mechanical trauma to within industry standards. In lens manufacturing, for a given material with a given refractive index, this is usually achieved by assigning a minimum thickness value to different zones within the lens and producing the lens so that its minimum thickness in at least one zone (and usually only one zone), is exactly as thick as that minimum value prescribed. Such zones typically include the edges of the edged lens (once it has been cut to be inserted into the frame), the prism reference point (also known as the PRP, which is a technical term for a point near the center of a lens), and/or zones of the lens that are to be drilled for the insertion of screws. In most cases, the thickness in the other zones would be larger than the minimum thickness needed to obtain sufficient structural strength within those zones.

As an example, negative-powered lenses tend to be quite thick at the edge of the lens, yet just thick enough at the center of the lens to have sufficient structural strength. Contrarily, positive powered lenses are usually thick at the center of the lens and just thick enough at the edges to achieve sufficient structural strength. In the former case, in which the lens is thin at the center and thick at the edges, the diameter of the unedged lens prior to edging does not affect the thickness of the lens once it is edged per a particular frame shape. In the second case, however, in which the minimum thickness at the edges is exactly at the tolerance for strength, the size of the uncut diameter prior to edging has a direct effect on the thickness of the lens after edging. In this case, the larger the unedged lens is prior to edging, the thicker the lenses will be at the center of the lens after edging per each individual frame shape. It is clear, therefore, that using an unedged lens diameter optimal for each frame shape is an important factor to providing lenses that are as thin as possible in the second case discussed above.

In the case of a progressive lens that is formed using a rigid stock lens as the base lens, the stock lens typically has a pre-set diameter (i.e., the lens diameter cannot be changed per individual frame shape). In accordance with the above explanation, some of the resulting lenses will be excessively thick, because the pre-set diameter that was used to produce them was not optimized for the frame shape. In accordance with some applications, the base lens is a bespoke base lens that is formed with an unedged diameter that is optimized to accommodate a given frame shape (which typically means that the lens is cut to the shape of the frame along with some spare area at the edges needed for edging processes). This can reduce the lens thickness in cases in which the driving thickness for maintaining sufficient strength is at the edge of the lens relative to if the base lens is a stock base lens that is manufactured with a pre-set unedged diameter unassociated with the frame shape.

For some applications, using a bespoke lens as the base lens can also be used to reduce the thickness of the resulting progressive lens using the following mechanism. Since the base lens is designated to be edged and mounted into a frame only after the additional lens is adhered to it, the base lens may be manufactured with a thickness that yields a structural strength that is below a threshold (e.g., with a thickness that would render the base lens not structurally strong enough to withstand mechanical trauma, per industry standards if it was tested stand-alone). Similarly, the additional lens may be manufactured with a thickness that yields a structural strength that is below a threshold (e.g., with a thickness that would render the additional lens not structurally strong enough to withstand mechanical trauma per industry standards if it was tested stand-alone). However, the base lens and the additional lens may be designed such that their combined structural strength is above the threshold (e.g., above or at the industry standard). Alternatively or additionally, adhesive 25 that is used to adhere the base lens to the additional lens may act as a shock absorber, such that the combined structural strength of the overall progressive lens is greater than the combination of the base lens and the additional lens in the absence of adhesive. Thus, although even the combination of the bespoke, single-vision base lens and the additional lens may have a structural strength at a given region that is below a threshold, in some embodiments, the adhesive acts as a shock absorber such that the progressive lens has a structural strength at the given region that is above the threshold.

### Advantages Over Using a Bespoke, Single-Piece, Progressive Lens

As described hereinabove, manufacturing the progressive lens using a combination of a bespoke, single-vision base lens (e.g., a freeform base lens) and an additional lens may provide one or more advantages over using a single-piece, bespoke progressive lens, e.g., a single-piece, freeform lens. Some of these advantages are as follows:

### Thickness Optimization

As described hereinabove, for some applications, using a bespoke, single-vision lens (e.g., a freeform lens) as the base lens in combination with an additional lens that provides the progressive near-vision corrective functionality, can be used to reduce the thickness of the progressive lens relative to a single-piece, bespoke progressive lens using the following mechanism. Since the bespoke base lens is intended to be edged and mounted into a frame only after the additional lens is adhered to it, the base lens may be manufactured with a minimum thickness that would render it not structurally strong enough to withstand mechanical trauma per industry standards if it was tested stand-alone. Similarly, the additional lens may be manufactured with a minimum thickness that would render it not structurally strong enough to withstand mechanical trauma per industry standards if it was tested stand-alone. However, as described hereinabove, the base lens and the additional lens may be designed such that their combined structural strength is above or at the industry standard.

For some applications, adhesive 25 that is used to adhere the base lens to the additional lens is configured to act as a shock absorber, such that the combined structural strength of the overall progressive lens is greater than the combination of the base lens and the additional lens in the absence of adhesive. The effect of adhesive on the impact resistance of laminated plastics is described in a Technical Report entitled “Effect of Adhesive on the Impact Resistance of Laminated Plastics for Windshield Applications,” by Joyce L. Illinger and Robert W. Lewis (Organic Materials Research for Army Materiel Agency Accession Number DA OD4693, August 1973). The Abstract of the Technical Report states that using certain adhesives (flexible, transparent, segmented polyurethane adhesives) to form laminates was found to increase the ballistic resistance of the laminates by approximately 40 percent relative to laminates that were formed via clamping. For some applications, the adhesive that adheres the base lens to the additional lens is used in a generally similar manner to that described in the aforementioned Technical Report, with the adhesive being configured to increase the impact resistance of the overall progressive lens relative to the impact resistance of the combination of the base lens and the additional lens in the absence of adhesive.

For some applications, adhesive 25 also serves an important role in the safety of eyewear upon impact. This is because even if the base lens or the additional lens were to fragment upon impact, the adhesive keeps the fragments adhered together and lessens their dispersion to a greater extent than a bespoke single-piece progressive lens that has no adhesive contained within its body.

Thus, for some applications, by using a combination of different materials for the base freeform lens and the additional lens, and/or by applying an adhesive layer between the base freeform lens and the additional lens, the overall progressive lens has greater structural strength than if the lens was to be formed from a single material (e.g., that of a freeform lens). Thus, the industry standard structural strength may be attained with a progressive lens having a lower overall thickness than if a single-piece bespoke lens was used as a progressive lens.

### Reduction in Manufacturing Time

Typically, subsequent to a bespoke lens (e.g., a freeform lens) being processed, one or more functional coatings are applied to the front and/or back surface of the lens, such as a hard coating, an anti-reflective coating, a super-hydrophobic coating, an antistatic coating, a clean coating, a blue-light filter, a reflective coating, an anti-UV coating, a photochromic coating, a polarizing coating, a tinting coating, a mirror coating, or any combination thereof. Further typically, this adds to the manufacturing time of the lens, since the processing of the lens takes time, and the application of the functional coating takes additional time and can only be performed subsequent to the lens having been processed. As described hereinabove, the additional lens is typically coupled to the back side of the bespoke base lens. Typically, for such applications, the one or more functional coatings are pre-applied to the front surface of the bespoke base lens, and the back surface of the bespoke base lens is processed according to a patient's particular needs. Further typically, the one or more functional coatings are pre-applied to the back surface of the additional lens. (It is noted that the coatings that are applied to the back surface of the additional lens are not necessarily identical to the coatings that are applied to the front surface of the bespoke base lens.) Thus, as soon as the bespoke base lens has been processed and the additional lens is adhered to the base lens, the functional coatings are already in place on the front and/or back surfaces of the progressive lens. Typically, this requires substantially less time than that required in order to apply functional coatings to a single-piece bespoke lens (e.g., a freeform lens). For some applications, the additional lens is coupled to the front side of the bespoke base lens, in which case the front surface of the additional lens and the back surface of the base lens are typically coated with the pre-applied coatings.

In many cases, lens coating cannot cost-effectively be applied on a per lens basis, and must be carried out in batches of several lenses. Lenses awaiting coating may await idly for significant lengths of time before enough lenses have been accumulated to sufficiently fill a batch in the coating machine. For this reason, the alternative method of production described hereinabove typically enables production time savings that are significantly larger than merely the coating process cycle time.

It will be appreciated by persons skilled in the art that the present invention is not limited to what has been particularly shown and described hereinabove. Rather, the scope of the present invention includes both combinations and subcombinations of the various features described hereinabove, as well as variations and modifications thereof that are not in the prior art, which would occur to persons skilled in the art upon reading the foregoing description.

1. An apparatus for use with a frame of glasses that are to be worn by a wearer, the apparatus comprising:
a progressive lens that is configured to provide a far-vision corrective functionality and a near-vision corrective functionality, the progressive lens comprising:
a bespoke, single-vision base lens that is configured to provide at least a portion of the far-vision corrective functionality, the bespoke lens being formed so as to accommodate ophthalmic requirements of the wearer, and/or requirements of the glasses frame; and
an additional lens coupled to the bespoke, single-vision base lens, the additional lens being configured to provide progressive near-vision corrective functionality.

2-3. (canceled)

4. The apparatus according to claim 1, wherein the additional lens is a stock lens.

5. The apparatus according to claim 1, wherein the bespoke, single-vision base lens is a freeform lens.

6. The apparatus according to claim 1, wherein the bespoke, single-vision base lens is a bespoke, single-vision base lens formed using hard-tool cutting and polishing.

7. The apparatus according to claim 1, wherein the bespoke, single-vision base lens is formed to accommodate ophthalmic requirements of the wearer selected from the group consisting of: sphere, cylinder, and axis.

8. The apparatus according to claim 1, wherein the bespoke, single-vision base lens is formed with single-vision refractive properties that are calculated to create an as-worn prescription that incorporates personalized ophthalmic parameters of the wearer.

9. The apparatus according to claim 1, wherein the bespoke, single-vision base lens is formed to compensate for any effect on personalized ophthalmic parameters that will be caused by the coupling of the additional lens to the bespoke, single-vision lens.

10. The apparatus according to claim 1, wherein the bespoke, single-vision base lens is formed to accommodate a clinical prism prescription of the wearer, such that the progressive lens has a required clinical prism correction at a prism reference point of the progressive lens.

11. The apparatus according to claim 1, wherein there is a thickness difference between top and bottom edges of the additional lens, and wherein prism-thinning is introduced to the bespoke, single-vision base lens, such that there is a thickness difference between top and bottom edges of the bespoke, single-vision base lens that at least partially compensates for the thickness difference between the top and bottom edges of the additional lens.

12. The apparatus according to claim 1, wherein residual optical properties are added in a periphery of the bespoke, single-vision base lens, so as to compensate for undesired residual peripheral aberrations that are caused by a discrepancy between prescription powers for which the additional lens was designed, and a prescription which the wearer requires.

13. The apparatus according to claim 1, wherein the bespoke, single-vision base lens is formed with an unedged diameter that is optimized to accommodate a shape of the frame of the glasses.

14. The apparatus according to claim 1, wherein each of the bespoke, single-vision base lens and the additional lens has a thickness at a given region that results in a lens having structural strength that is below a given threshold for that region, but the progressive lens has a structural strength at the given region that is above the threshold.

15. The apparatus according to claim 1, wherein a combination of the bespoke, single-vision base lens and the additional lens has a structural strength at a given region that is below a threshold for that region, and wherein the additional lens is coupled to the bespoke, single-vision base lens with an adhesive that acts as a shock absorber such that the progressive lens has a structural strength at the given region that is above the threshold.

16. The apparatus according to claim 1, wherein residual optical properties are added in a periphery of the bespoke, single-vision base lens, so as to compensate for a mismatch between a face form angle for which the additional lens is designed, and a face form angle of the frame of the glasses.

17. (canceled)

18. The apparatus according to claim 16, wherein the residual optical properties that are added are configured to account for one or more personalized ophthalmic parameters of the wearer selected from the group consisting of: back vertex distance, pantoscopic tilt, and prism.

19. The apparatus according to claim 1, wherein the progressive lens comprises one or more functional coatings that were pre-applied to at least one of a front surface of the progressive lens and a back surface of the progressive lens, prior to the additional lens being coupled to the bespoke, single-vision base lens.

20. (canceled)

21. The apparatus according to claim 19, wherein the progressive lens comprises a first set of one or more functional coatings that were pre-applied to the front surface of the progressive lens and comprises a second set of one or more functional coatings that were pre-applied to the back surface of the progressive lens, prior to the additional lens being coupled to the bespoke, single-vision base lens.

22-23. (canceled)

24. The apparatus according to claim 1, wherein there is a thickness difference between top and bottom edges of the additional lens, and wherein prism-thinning is introduced to the bespoke, single-vision base lens, such that top and bottom edges of the bespoke, single-vision base lens do not compensate for the thickness difference between the top and bottom edges of the additional lens, such that there is a difference between the thicknesses of top and bottom edges of the progressive lens.

25. The apparatus according to claim 24, wherein the progressive lens has an average thickness on its edged contour that is lower than it would be if the bespoke single vision lens provided prism-thinning, such that top and bottom edges of the bespoke, single-vision base lens compensated for the thickness difference between the top and bottom edges of the additional lens.

26. The apparatus according to claim 1, wherein the bespoke, single-vision base lens includes one or more corrections selected from the group consisting of: aspheric correction, anti-fatigue correction, oblique aberration correction, and/or myopia-control correction.

27. The apparatus according to claim 26, wherein the selected one or more corrections change a mean power of the bespoke, single-vision base lens at a near vision measuring position by no more than 0.125 Diopters relative to a mean power of the bespoke, single-vision base lens at a far vision measuring position.

28. A method for use with a frame of glasses that are to be worn by a wearer, the method comprising:
manufacturing a progressive lens for placement in the glasses frame by:
coupling to each other:
a bespoke, single-vision base lens that is configured to provide at least a portion of the far-vision corrective functionality, the bespoke lens being formed so as to accommodate ophthalmic requirements of the wearer, and/or requirements of the glasses frame; and
an additional lens coupled to the bespoke, single-vision base lens, the additional lens being configured to provide progressive near-vision corrective functionality.

29-54. (canceled)
